(19) United States
(12) Patent Application Publication
(10) Pub. No.: US 2010/0248557 A1
(43) Pub. Date: Sep. 30, 2010

(54) ELECTRICAL CONTACT STRIP HAVING SUPPORTING PORTIONS FOR PROTECTING CONTACTS THEREOF

(75) Inventor: CHIA-WEI FAN, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/750,585

(22) Filed: Mar. 30, 2010

(30) Foreign Application Priority Data
Mar. 31, 2009 (TW) 98205146

(51) Int. Cl. H01R 4/48; H01R 13/02

(52) U.S. Cl. 439/816; 439/885

(57) ABSTRACT

An electrical contact strip comprises a carrier and a plurality of contacts projecting from and linking with the carrier. A plurality holes are defined on the carrier for securing the carrier. A plurality of supporting portions and protrude beyond the contact in a thickness direction for protecting the contacts.

### BACKGROUND OF THE INVENTION

1. Field of the Invention

The present invention relates to a carrier strip, and more particularly to a contact carrier strip in which a stand off is formed along with each contact terminal such that a geometry of the contact terminal is well protected when the carrier strip is rolled up.

2. Description of Related Art

Electrical connector typically has a plurality of contacts for establishing electrical connection between an electronic package and a printed circuit board. The contacts are known to be configured on a metal strip before assembled to the electrical connector so that it easy to automatic mass production, plating and assembly the contacts.

Taiwanese Utility Pat. No. 362635 issued to Liu on Jun. 21, 1999 discloses a piece of a metal strip including a contact carrier and an assistant carrier connecting and being coplanar with the contacts carrier. The contact carrier has a contact strip with a plurality of contacts and anchor holes formed thereon, and the assistant carrier has also been provided with a plurality of supporting portions and holes. The supporting portions extend outwardly from two opposite sides of the strip and each has a curved section at a free end thereof. The supporting portions extend beyond free ends of the contacts so as to withstand exterior force prior to the contacts. Therefore, the contacts will not be easily damaged and deformed during packaging, moving and placing. However, the strip needs to have an adequate width due to formation of the assistant carrier, furthermore, the assistant carrier will be scraped when the contacts are assembled to the electrical connector, that will increase costs and waste material.

Chinese Utility Pat. No. 201122788 issued to Liu on Sep. 24, 2008 further discloses a contact strip assembly generally having a plurality of contacts protruding from the contacts strip. The contact strip comprises a base, linkage portions extending from one side of the base to connecting with the contacts, and supporting portions disposed on the opposite side of the base. Although this contact strip assembly does not have the assistant strip as what above-mentioned Liu '635 disclosed. However, the supporting portions located at an edge of the base also increase a width of the contact strip and the cost.

Therefore, an improved contact strip is needed.

### SUMMARY OF THE INVENTION

An object of the present invention is to provide an electrical contact strip having supporting portions extending from holes thereof to save material and reduce cost.

To achieve the aforementioned object, an electrical contact strip comprises a carrier and a plurality of contacts projecting forwardly from of the contact strip. A plurality holes are defined on the carrier for aligning and advancing the carrier and a plurality of supporting portions formed from the formation of the holes. Each supporting portion projects forwardly from an inner edge of the hole to an extent that is beyond an outmost point of the contact terminal.

To achieve the aforementioned object by another project, an electrical contact strip comprises a carrier defining a datum plane itself and a plurality of contacts. The contacts have a first length protruding from the datum plane in a thickness direction of the contact strip. A plurality of holes defines in the carrier and a plurality of supporting portions. Each supporting portion extends from corresponding holes and has a second length protruding from the datum plane in the thickness direction of the carrier, and the second length is longer than the first length.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view of a contact strip in accordance with the present invention;

FIG. 2 is a front view of the contact strip shown in FIG. 1;

FIG. 3 is a side view of the contact strip shown in FIG. 2; and

FIG. 4 is a schematic view, showing a state of the contact strip during processing.

### DETAILED DESCRIPTION OF THE INVENTION

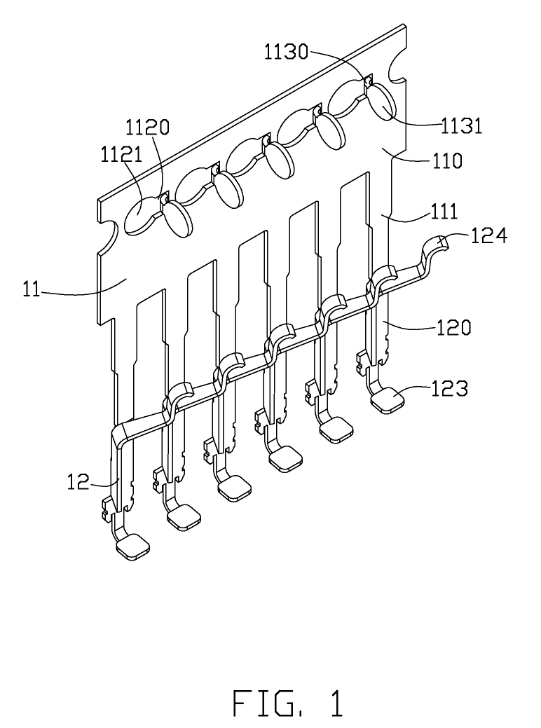

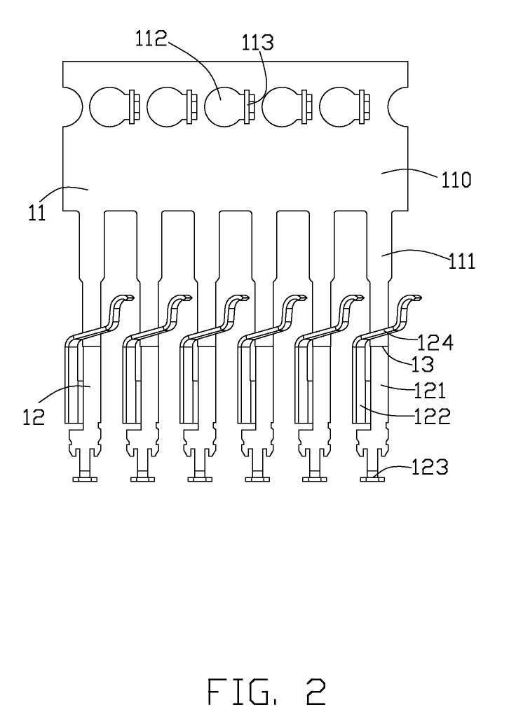

Referring to FIGS. 1 and 2, an electrical contact strip has a lead-in carrier 11 and a plurality of contacts 12 connecting with the lead-in carrier 11.

The lead-in carrier 11 is configured with a zonal base 110 with a plurality of linkage portions 111 extending from bottom side of the base 110. The base 110 defines a row of holes 112 arranged along the base's 110 extending direction, each hole 112 configured with an dowel hole 1121 and a receiving hole 1120 communicating with the dowel hole 1121. A supporting portion 113 includes a curved portion 1130 bent outwardly from an inner edge of the receiving hole 112 and a supporting section 1131 connecting with the curved portion 1130. The supporting section 1131 extends perpendicularly to the base 110.

The contact 12 is configured with a main body 120 with a spring portion 124 extending upwardly thereof, and further with a soldering portion 123 extending downwardly thereof. The main body 120 has a first main body 121 connecting with the linkage portion 111 with a cutting recess 13, and a second main body 122 extending from one lateral side of the first main body 121 and having an angle with the first main body 121. The spring portion 124 extends from the second main body 122 and projects outwardly from the base 110 of the lead-in carrier 11. The soldering portion 123 extends perpendicularly to the first main body 121. In this embodiment, the spring portion 124, the second main body 122, and the soldering portion 123 are all projected outwardly from the base 110 and located at a front side of the base 11.

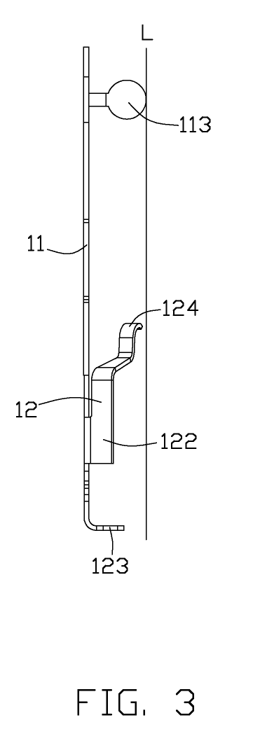

FIG. 3 shows a side view of the contact strip. The base 110 defines as a datum plane itself, and the supporting portion 113 extends forwardly from the datum plane till a line L, the spring arm 124 also extends forwardly but does not reach to the line L, in other word, the supporting portion 113 extends beyond the contact 12 in the thickness direction of the contact strip so that an outside force will exert on the supporting portion 113 to prevent the contact 12 from damage.

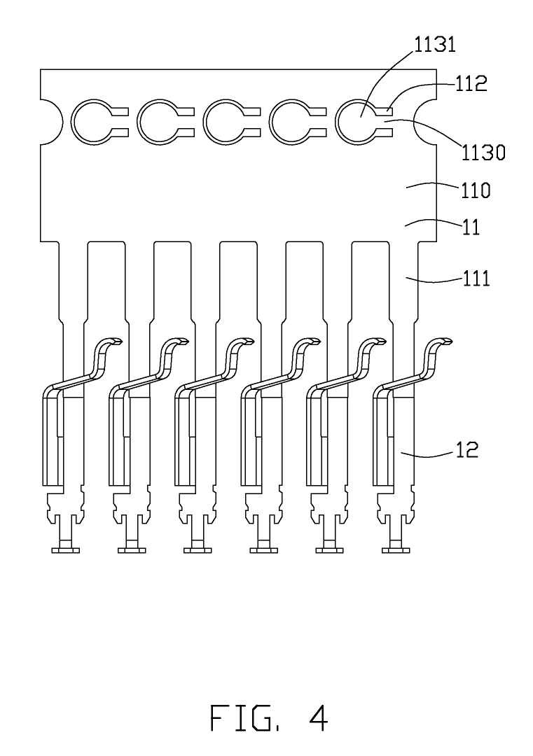

FIG. 4 is a schematic view of the contact strip in processing showing the supporting portions 113 are located in the holes 112 of the base 110. The contact strip is configured with a carrier and is stamped to form the holes 112, the supporting portions 113 in corresponding holes 112, and the contacts 12 in plane shape, then, the supporting portions 113 are bent forwardly from the holes 112, and the contacts 112 are bent to form final configuration from the carrier.

In the present invention, the supporting portions 113 are made in the corresponding holes 112 by punching, it not only rationally uses the metal strip but also reduces the width of the contact strip for cost down.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An electrical contact strip comprising:
a carrier;
a plurality of contacts projecting forwardly from of the contact strip;
a plurality holes defined on the carrier for aligning and advancing the carrier; and
a plurality of supporting portions formed from the formation of the holes, each projecting forwardly from an inner edge of the hole to an extent that is beyond an outmost point of the contact terminal.

2. The electrical contact strip as claimed in claim 1, wherein the supporting portion is perpendicular to the carrier.

3. The electrical contact strip as claimed in claim 2, wherein the supporting portion has a similar configuration with the hole.

4. The electrical contact strip as claimed in claim 1, wherein the hole includes an dowel hole for securing the carrier and a receiving hole linking with the supporting portion.

5. The electrical contact strip as claimed in claim 4, wherein the supporting portion comprises a curved portion bent from the receiving hole and a supporting section extending from the curved portion and perpendicular to the carrier.

6. The electrical contact strip as claimed in claim 1, wherein the contact is configured with a main body with a spring arm extending upwardly and a soldering portion extending perpendicularly to the main body.

7. The electrical contact strip as claimed in claim 6, wherein the main body includes a first main body connecting with the carrier and a second main body extending from a lateral side of the first main body and connecting with the spring arm.

8. The electrical contact strip as claimed in claim 7, wherein the second main body, the spring arm, and the soldering portion are all disposed in front of the carrier.

9. An electrical contact strip comprising:
a carrier defining a datum plane itself;
a plurality of contacts having a first length protruding from the datum plane in a thickness direction of the contact strip;
a plurality of holes defined in the carrier; and
a plurality of supporting portions, each extending from corresponding holes and having a second length protruding from the datum plane in the thickness direction of the carrier, and the second length being longer than the first length.

10. The electrical contact strip as claimed in claim 9, wherein the holes are defined along the carrier's extending direction.

11. The electrical contact strip as claimed in claim 9, wherein the supporting portions are disposed perpendicular to the datum plane.

12. The electrical contact strip as claimed in claim 9, wherein each hole comprises a dowel hole for securing the contact strip and a receiving hole communicating with the dowel hole.

13. The electrical contact strip as claimed in claim 9, wherein the supporting portion is configured with a curved portion and a supporting section connecting with the curved portion.

14. The electrical contact strip as claimed in claim 9, wherein the hole has a similar configuration with the supporting portion.

15. The electrical contact strip as claimed in claim 9, wherein the contact comprises a first main body located in the datum plane, a second main body connecting with the first main body and extending outwardly, a spring arm extending upwardly from the second main body and a soldering portion extending downwardly and perpendicularly to the second main body.

16. An electrical contact strip comprising:
a carrier having a main face defining a datum plane thereof;
a plurality of contacts unitarily stamped and extending from the carrier and having a distal end spaced from the datum plane with a first distance;
a plurality of supporting portions, respectively opposite to the corresponding contacts, stamped and extending from the carrier and having a distal tip spaced from the datum plane with a second distance larger than the first distance; wherein
said supporting portion is not a part of the corresponding contact for use but of waste material after removal of the contact from the carrier.
